(19) United States
(12) Patent Application Publication
(10) Pub. No.: US 2006/0060659 A1
(43) Pub. Date: Mar. 23, 2006

(54) Controlled-environment cargo container

(75) Inventor: Robert Dale, Vancouver (CA)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Coldwall, Inc.

(21) Appl. No.: 11/194,121

(22) Filed: Jul. 29, 2005

Related U.S. Application Data
(63) Continuation of application No. 10/714,589, filed on Nov. 13, 2003.
(60) Provisional application No. 60/427,146, filed on Nov. 15, 2002.

(51) Int. Cl. F24F 3/14; F25D 3/08; G05D 22/02; F24F 11/00

(52) U.S. Cl. 236/44 C; 62/371

(57) ABSTRACT

A method and apparatus for controlling the environment of cargo through lateral ventilation. The method provides for a controlled fluid to be supplied into a cargo compartment having a lateral portion, the fluid being supplied through a vent in a supply-conduit adjacent the lateral portion. In practice, this result can be achieved by building a structure that encloses a cargo compartment having a lateral portion, running a supply-conduit adjacent the lateral portion, connecting the supply-conduit to receive a controlled fluid from outside the cargo compartment, and conducting the fluid into the cargo compartment through a vent in the supply-conduit. On mixing with the environment within the cargo compartment, the fluid will influence components of the environment, for example the humidity and the temperature.

### BACKGROUND OF THE INVENTION

### FIELD OF THE INVENTION

The present invention relates to controlled-environment cargo containers, and more particularly to a method and apparatus for controlling components of a cargo container's environment, for example temperature and humidity.

### SUMMARY OF THE INVENTION

The present invention is directed to configuring cargo containers to promote a horizontal flow in the container environment. As an additional benefit, when containers are so configured, certain expensive and ineffective components typically required in conventional containers may be omitted.

### BRIEF DESCRIPTION OF THE DRAWINGS

These and other objects, features and advantages of the present invention will become more readily apparent upon considering the following detailed description of specific embodiments, with reference to the accompanying drawings where like numbers reference like elements, in which:

FIG. 1 is a perspective side view of a cargo container according to one embodiment of the present invention;

FIG. 2 is a transverse sectional view of the cargo container of FIG. 1, looking from a second end toward a first end;

FIG. 3 is a plan sectional view of the cargo container of FIG. 1, a horizontal cutting plane passing through a roof assembly;

FIG. 4 is a longitudinal sectional view of the cargo container of FIG. 1, looking from a second side toward a first side, a vertical cutting plane having removed the first side from this view;

FIG. 5 is a longitudinal sectional view of a cargo container according to a second embodiment of the invention, looking from a second side toward a first side, a vertical cutting plane having removed the first side from this view;

FIG. 6 is a longitudinal sectional view of a cargo container according to a third embodiment of the invention, looking from a second side toward a first side, a vertical cutting plane having removed the first side from this view;

FIG. 7 is a plan sectional view of a cargo container according to a fourth embodiment of the invention, a horizontal cutting plane passing through a roof assembly;

FIG. 8 is a plan sectional view of a cargo container according to a fifth embodiment of the invention, a horizontal cutting plane passing through a roof assembly; and

FIG. 9 is a plan sectional view of a cargo container according to a sixth embodiment of the invention, a horizontal cutting plane passing through a roof assembly.

### DETAILED DESCRIPTION

1. Structure

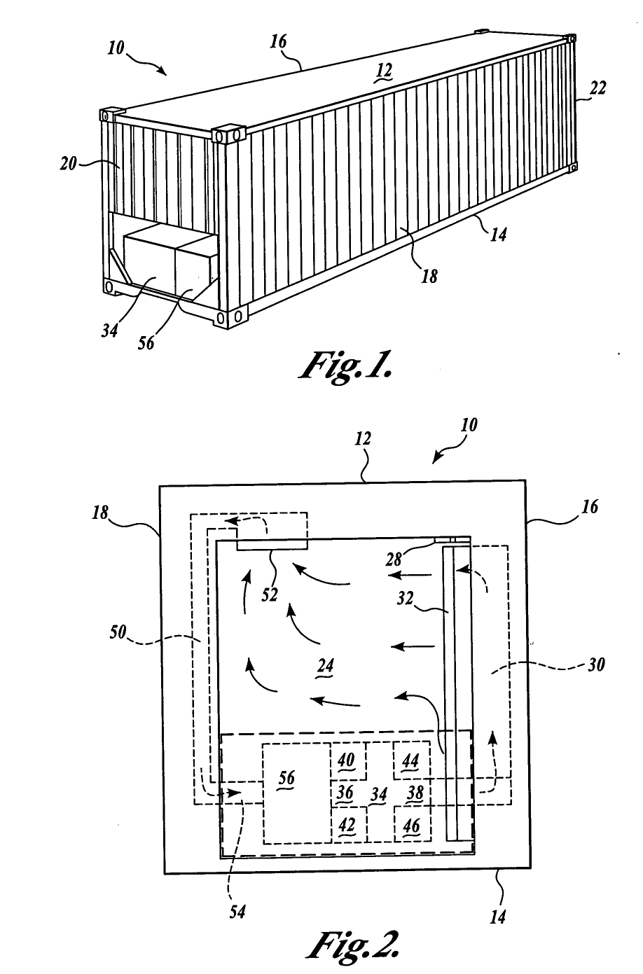

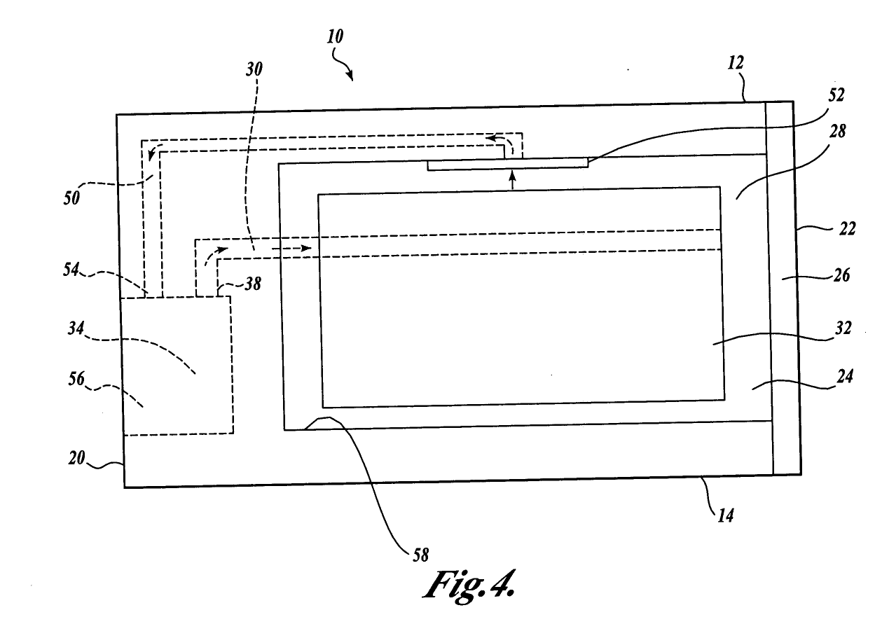

Referring first to FIGS. 1 through 4, a cargo container according to one embodiment of the present invention is generally illustrated at 10. The cargo container includes a roof assembly 12, a floor assembly 14, first and second opposing side assemblies 16, 18, and first and second opposing end assemblies 20, 22 that cooperate to form an enclosed cargo compartment 24. It will be appreciated that the cargo compartment 24 could be enclosed by a different arrangement of assemblies without departing from the spirit of the invention. In this embodiment, the second end assembly includes a door sub-assembly 26 which has an open position to provide access to the cargo compartment 24 and an alternative closed position to seal the cargo compartment 24.

At least one of the first and second side assemblies 16, 18 includes a lateral portion 28 within the cargo compartment 24.

The cargo container 10 further includes a supply-conduit 30 adjacent the lateral portion 28 of the cargo compartment 24. The supply-conduit 30 is placed, arranged, fitted and otherwise adapted to receive therewithin a fluid from outside the cargo compartment 24. In this embodiment, the supply-conduit 30 is formed integrally from the structure of the cargo container 10, and more particularly is illustrated as an integral portion of the first side assembly 16.

The supply-conduit 30 includes a vent 32 passing radially therethrough and adapted to conduct the fluid within the supply-conduit 30 into the cargo compartment 24. In this embodiment, the fluid conducted by the supply-conduit is substantially air.

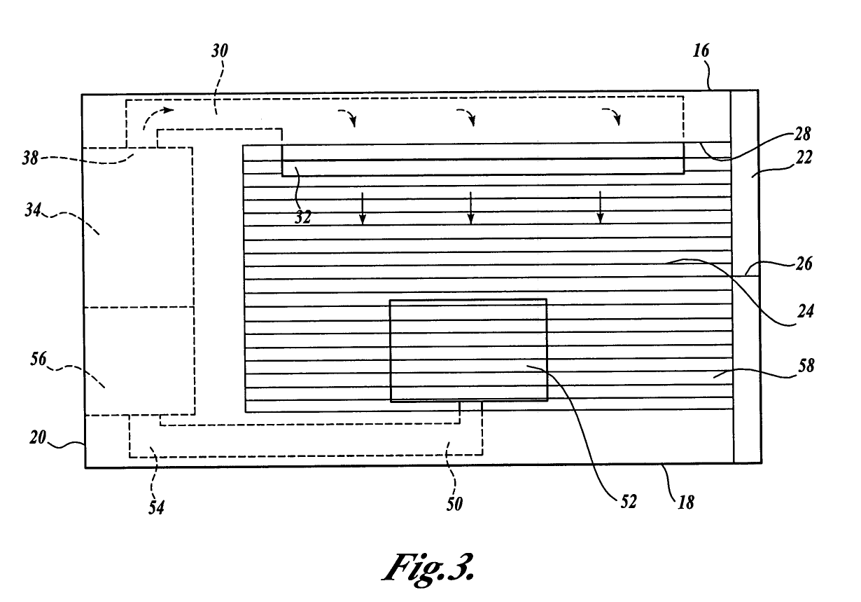

Although the supply-conduit 30 is operable so as to ventilate the cargo compartment 24 with fluid received from outside the cargo compartment 24, the cargo container 10 may also include a controller 34 having an input port 36 adapted to receive a fluid and an output port 38 adapted to supply the fluid received at the input port 36. The controller 34 is operable to urge an environmental component of the fluid supplied at the output port 38 toward a desired value. For example, the controller 34 might include a heater 40 for increasing the temperature of the fluid, a cooler 42 for decreasing the temperature of the fluid, a humidifier 44 for increasing the humidity of the fluid, or a dehumidifier 46 for decreasing the humidity of the fluid. These aspects are shown diagrammatically in FIG. 2, for example. In this embodiment, the output port 38 of the controller 34 is connected to supply fluid to the supply-conduit 30 so as to provide more control over the environment within the cargo compartment 24.

The cargo container 10 may additionally include a return-conduit 50 having a first end 52 connected to the cargo compartment 24 and a second end 54 connected to the input port 36 of the controller 34. So arranged, the return-conduit 50 is operable to conduct fluid from the cargo container 24 to the controller 34, so as to form a closed system with the supply-conduit 30 and the controller 34 for controlling and recirculating fluid. In this embodiment, the return-conduit 50 follows along the roof assembly 12; however, other placements would be possible without departing from the spirit of the invention.

The cargo container 10 may further include a pump or fan 56 connected in series with the supply-conduit 30, the controller 34 and the return-conduit 50. The pump or fan 56 is operable to provide additional motive force for circulating the fluid, beyond any thermodynamic forces otherwise present in the passive system formed by the supply-conduit 30, the controller 34 and the return-conduit 50.

Finally, because no ducting need follow along the floor assembly 14, there is no need to include T-rail floor panels. Thus in this embodiment, the floor assembly 14 includes a simple and robust corrugated floor 58.

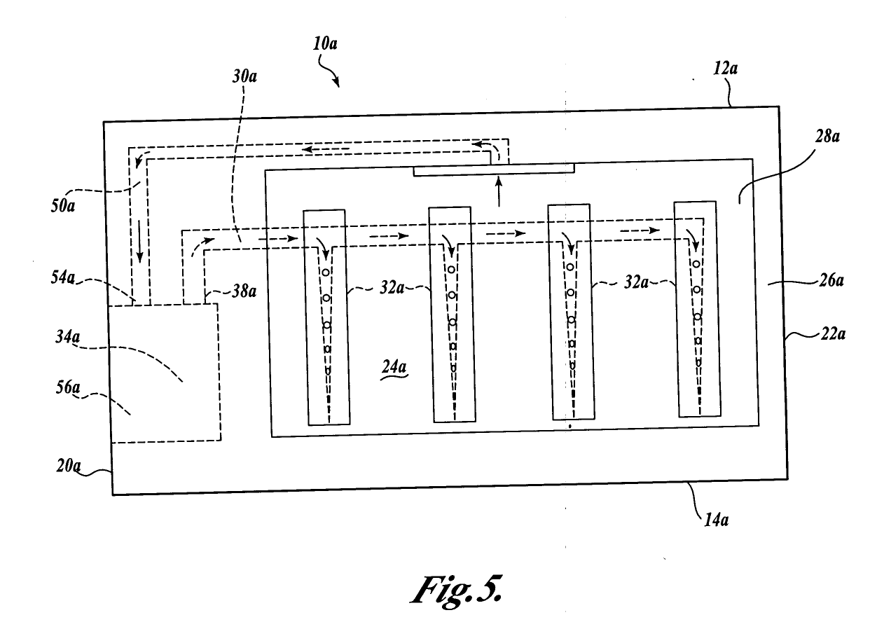

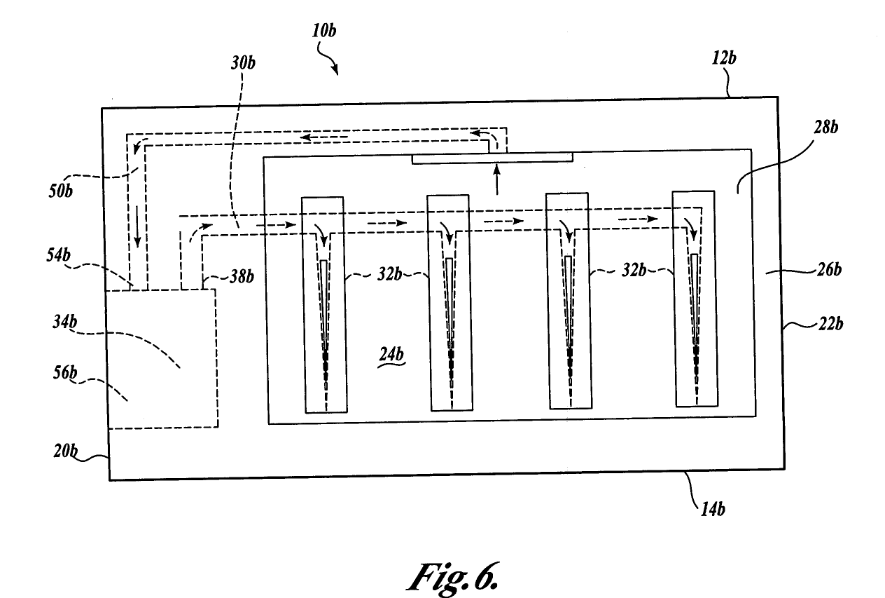

Referring now to FIG. 5, a cargo container according to a second embodiment of the invention is generally illustrated at 10a. In this embodiment, the vent 32a is elongated and oriented substantially vertically within the cargo compartment 24a. The vent 32a may extend substantially from the top of the cargo compartment 24a proximate the roof assembly 12a to the bottom of the cargo compartment 24a proximate the floor assembly 14a. The vent 32a defines a plurality of holes 60a through the supply-conduit 30a that are each adapted to conduct fluid within the supply-conduit 30a into the cargo compartment 24a.

Referring now to FIG. 6, a cargo container according to a third embodiment of the invention is generally illustrated at 10b. In this embodiment, the vent 32b is also elongated and oriented substantially vertically within the cargo compartment 24b and may extend substantially from the top of the cargo compartment 24b proximate the roof assembly 12b to the bottom of the cargo compartment 24b proximate the floor assembly 14b. However, in this third embodiment, the vent 32b defines an elongated slot 60b through the supply-conduit 30b that is adapted to conduct fluid within the supply-conduit 30a into the cargo compartment 24b.

Referring briefly to both FIGS. 5 and 6, the interior cross-section of the supply-conduit 30a, 30b may vary inversely with the distance between the cross-section and the fluid supply at the output port 38a, 38b of the controller 34a, 34b as measured along the longitudinal axis of the supply-conduit 30a, 30b. This decreasing interior cross-section at portions of the supply-conduit 30a, 30b remote from the controller 34a, 34b helps to make the pressure of fluid within the supply-conduit 30a, 30b more uniform throughout its length.

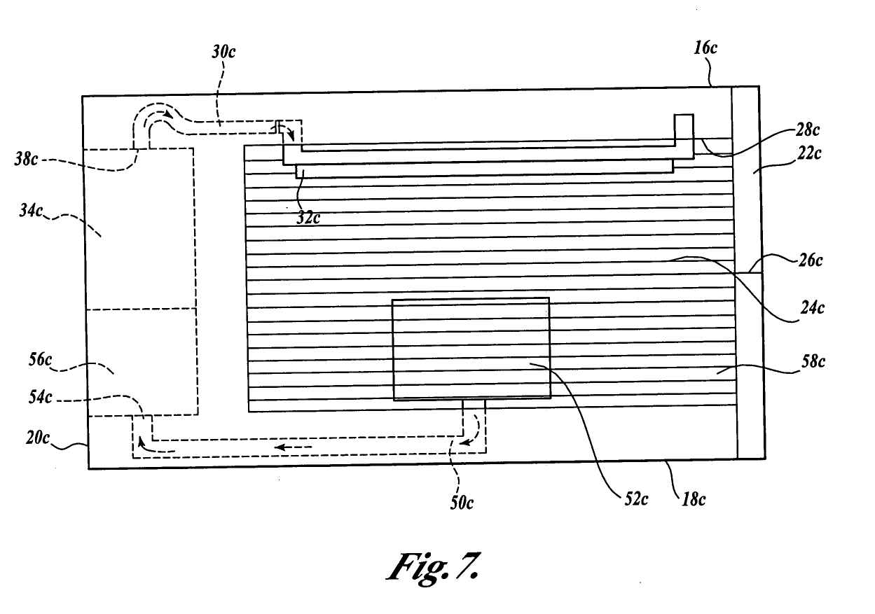

Referring now to FIG. 7, a cargo container according to a fourth embodiment of the invention is generally illustrated at 10c. In this embodiment, the supply-conduit 30c is an independent assembly separate from the structure of the cargo container 10c. The supply-conduit 30c may be attached to the cargo container 10c, and as illustrated is attached to the lateral portion 28c of the cargo compartment 24c.

Referring briefly now to FIGS. 2 and 7, it can be observed that the supply conduit 30, 30c in the first and fourth embodiments is substantially within the cargo compartment 24, 24c.

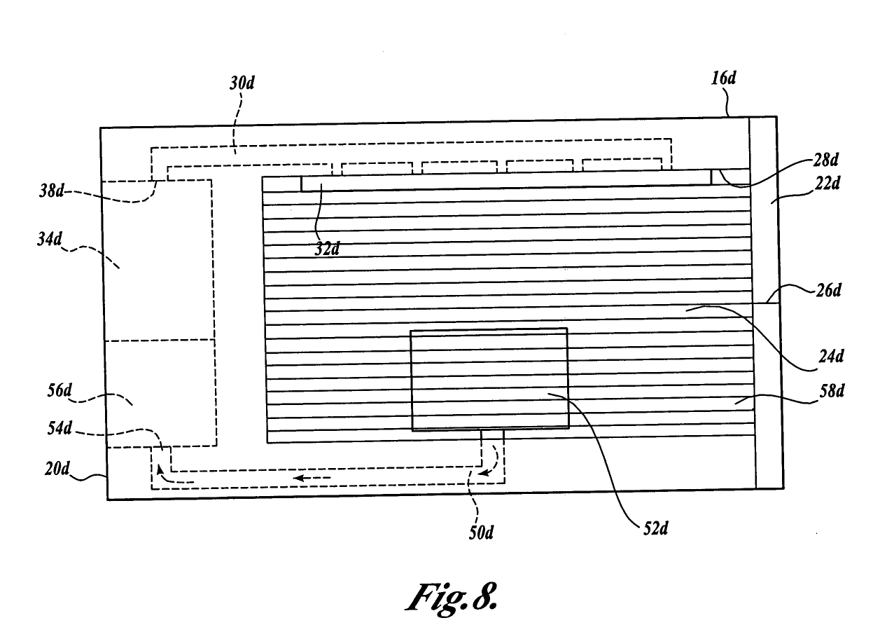

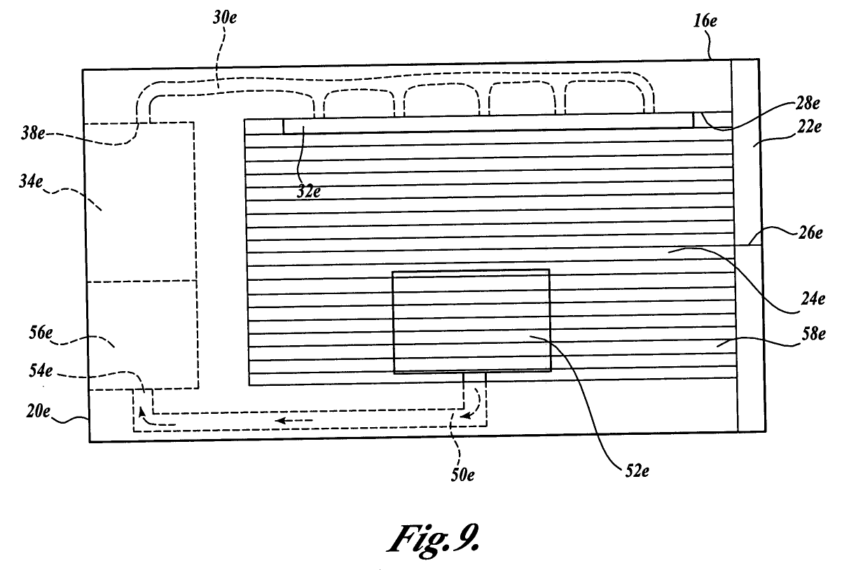

Referring now to FIG. 8, a cargo container according to a fifth embodiment of the invention is generally illustrated at 10d. Just as in the first embodiment of the cargo container 10, the supply-conduit 30d is formed integrally from the structure of the cargo container 10d, and more particularly is illustrated as an integral portion of the first side assembly 16d. However, in the case of the fifth embodiment, the supply-conduit 30d is substantially outside the cargo compartment 24d.

Referring finally now to FIG. 9, a cargo container according to a sixth embodiment of the invention is generally illustrated at 10e. Just as in the fourth embodiment of the cargo container 10c, the supply-conduit 30e is an independent assembly separate from the structure of the cargo container 10c. However, while the supply-conduit 30e may be attached to the cargo container 10c, in this sixth embodiment it is substantially outside the cargo compartment 24e.

2. Operation

Referring now to FIGS. 1 through 9, the operation of the six embodiments of the cargo container 10, 10a, 10b, 10c, 10d, 10e will now be described. Except when reference is being made specifically to an alternate feature of one of the alternate embodiments, the alphabetic suffixes will be omitted from all reference numbers for the purpose of simplicity.

With the door sub-assembly 26 placed in its open position, the cargo compartment 24 is made accessible for loading cargo. The corrugated floor 58 incorporated into the floor assembly 14 provides a robust surface for loading and securing the cargo and the corrugations help to carry any water that may accumulate within the cargo compartment 24 away from the cargo. Once the cargo has been loaded into the cargo compartment 24, the door sub-assembly 26 is placed in its closed position to seal the cargo compartment 24.

Either during loading or after the cargo compartment 24 has been sealed, an operator can set the controller 34 to urge an environmental component of the fluid supplied at the output port 38 toward a desired value, for example a desired temperature or humidity. The operator can also engage the pump or fan 56 to provide motive force to circulate the fluid through the controller 34 to the supply-conduit 30, on through the vent 32 into the cargo compartment 24, and then back through the return-conduit 50 to the controller 34.

With the supply-conduit 30, the vent 32, and the return-conduit 50 being oriented as previously described, the fluid flow through the cargo compartment 24 has a significant horizontal component, as is advantageously found in warehouse facilities.

While specific embodiments of the invention have been described and illustrated, such embodiments should be considered illustrative of the invention only.

What is claimed is:

1. An apparatus, comprising:
a. a structure that defines a cargo compartment having a lateral portion,
b. a supply-conduit adjacent the lateral portion and adapted to receive therewithin a fluid from outside the cargo compartment, and
c. a vent through the supply-conduit adapted to conduct the fluid within the supply-conduit into the cargo compartment.

2. An apparatus as claimed in claim 1, further comprising a controller having an input port adapted to receive a fluid and an output port adapted to supply the received fluid, wherein the output port is connected to supply fluid to the supply-conduit and the controller is operable to urge an environmental-component of the supplied fluid toward a desired value.

3. An apparatus as claimed in claim 2, wherein the environmental component is temperature.

4. An apparatus as claimed in claim 2, wherein the environmental component is humidity.

5. An apparatus as claimed in claim 2, further comprising a return-conduit having a first end connected to the cargo compartment and a second end connected to the input port of the controller and operable to conduct fluid from the cargo compartment to the controller.

6. An apparatus as claimed in claim 5, further comprising a pump connected in series with the controller, the supply-conduit, and the return conduit and operable to urge fluid therethrough.

7. An apparatus as claimed in claim 6, wherein the fluid comprises air.

8. An apparatus as claimed in claim 7, wherein the cargo compartment further includes a corrugated floor.

9. An apparatus as claimed in claim 1, wherein the vent is elongated and substantially vertical.

10. An apparatus as claimed in claim 9, wherein the vent extends substantially from the top of the cargo compartment to the bottom of the cargo compartment.

11. An apparatus as claimed in claim 10, wherein the vent defines a plurality of holes through the supply-conduit adapted to conduct the fluid within the supply-conduit into the cargo compartment.

12. An apparatus as claimed in claim 10, wherein the vent defines an elongated slot through the supply-conduit adapted to conduct the fluid within the supply-conduit into the cargo compartment.

13. An apparatus as claimed in either claim 11 or claim 12, wherein the interior cross-section of the supply-conduit varies inversely with the distance between the cross-section and the fluid supply as measured along the longitudinal axis of the supply-conduit.

14. An apparatus as claimed in claim 1, wherein the supply-conduit is formed integrally from the structure.

15. An apparatus as claimed in claim 1, wherein the supply-conduit is separate from the structure.

16. An apparatus as claimed in claim 15, wherein the supply-conduit is attached to the lateral portion of the cargo compartment.

17. An apparatus as claimed in either claim 14 or claim 15, wherein the supply-conduit is substantially within the cargo compartment.

18. An apparatus as claimed in either claim 14 or claim 15, wherein the supply-conduit is substantially outside the cargo compartment.

19. A method, comprising supplying a controlled fluid into a cargo compartment having a lateral portion, wherein the fluid is supplied through a vent in a supply-conduit adjacent the lateral portion.

20. A method as claimed in claim 19, further comprising controlling the temperature of the fluid.

21. A method as claimed in claim 19, further comprising controlling the humidity of the fluid.

22. A method as claimed in claim 19, further comprising extracting the fluid from the cargo compartment.

23. A method as claimed in claim 22, further comprising recirculating the fluid.

24. A method as claimed in claim 23, further comprising pumping the fluid.

25. A method as claimed in claim 24, wherein supplying a fluid comprises supplying air.

26. A method as claimed in claim 19, wherein the fluid is supplied at more than one elevation within the cargo compartment.

27. A method as claimed in claim 26, wherein the fluid is supplied at a plurality of discrete elevations within the cargo compartment.

28. A method as claimed in claim 26, wherein the fluid is supplied substantially continuously between an upper elevation and a lower elevation within the cargo container.

29. A method as claimed in claim 26, wherein a substantially similar volume of fluid is supplied at each of the more than one elevations within the cargo compartment.

30. A method as claimed in claim 19, wherein the fluid is supplied through a supply-conduit formed integrally from the structure forming of the cargo compartment.

31. A method as claimed in claim 19, wherein the fluid is supplied through a supply-conduit separate from the structure that forms the cargo compartment.

32. A method as claimed in claim 31, wherein the supply-conduit is attached to the lateral portion of the cargo compartment.

33. A method as claimed in either claim 30 or claim 31, wherein the fluid is supplied through a supply-conduit substantially within the cargo compartment.

34. A method as claimed in either claim 30 or claim 31, wherein the fluid is supplied through a supply-conduit substantially outside the cargo compartment.
